(19) United States
(12) Patent Application Publication
(10) Pub. No.: US 2015/0147014 A1
(43) Pub. Date: May 28, 2015

(54) Cage blank for freewheel with rolling elements, freewheel cage formed from such a blank, freewheel comprising such a cage, and method of mounting such a freewheel

(71) Applicants: Charles Chambonneau, Joue les Tours (DE); Samuel Viault, Saint-Antoine-du-Rocher (FR)

(72) Inventors: Charles Chambonneau, Joue les Tours (DE); Samuel Viault, Saint-Antoine-du-Rocher (FR)

(73) Assignee: AKTIEBOLAGET SKF, Göteborg (SE)

(21) Appl. No.: 14/552,963

(22) Filed: Nov. 25, 2014

(30) Foreign Application Priority Data
Nov. 25, 2013 (FR) 1361607

(51) Int. Cl. F16C 33/50; F16C 43/06

(52) U.S. Cl. CPC F16C 33/506; F16C 43/065
USPC 384/576; 384/572; 29/898.064

(57) ABSTRACT

A cage blank for a free wheel with rolling bodies is formed by an elongated strip defining housings for receiving rolling bodies juxtaposed in a rectilinear longitudinal direction of the blank. It is provided, at both of its ends, with means for attaching the two ends together, in a configuration where the cage forms a closed loop. A cage is formed by bending the blank on itself, perpendicular to its longitudinal direction, and engaging its attaching means.

### FIELD OF THE INVENTION

The invention relates to a cage blank for a free wheel with rolling bodies. Such a blank is used during the manufacture of a free wheel with rolling bodies, in order to produce a cage for keeping rolling bodies in position during use of the free wheel. The invention also relates to a free wheel cage formed from such a blank, as well as a free wheel comprising such a cage. Lastly, the invention relates to a method for assembling such a free wheel.

### BACKGROUND OF THE INVENTION

In the field of free wheels, it is known to keep the rolling bodies of the free wheel, such as rollers or beads, in position using a ring that defines housings for receiving and guiding rolling bodies, between the inner and outer rings of the free wheel. Such a ring may be formed by a folded and cut metal strip or by a ring made from molded synthetic material.

With this type of cage, the rolling bodies must be introduced successively into the cells of the cage from the inside thereof, which requires precise manipulations and a qualified workforce. This makes the price of a free wheel with rolling bodies higher.

The invention more particularly aims to resolve these drawbacks by proposing a cage blank for a free wheel that facilitates the placement of the rolling bodies and makes it possible to save time during the manufacturing of a free wheel.

To that end, the invention relates to a cage blank for a free wheel with rolling bodies that is made up of an elongated strip defining housings for receiving the rolling bodies juxtaposed in a longitudinal rectilinear direction of the blank, while the blank is provided, at both of its ends, with fastening means for fastening the two ends together, in a configuration where the cage forms a closed loop.

Owing to the invention, the blank may be equipped or “trimmed” with the different rolling bodies by accessing their respective housings via a single side of the blank, in particular by the top when the blank is placed flat. This facilitates an operator's work, or even it makes it possible to automate the task of placing rolling bodies. The invention also makes it possible to place rolling bodies in the housings simultaneously, which makes it possible to save considerable time relative to the prior art, where the various rolling bodies and/or cams must be introduced one after the other into their respective housings.

According to advantageous but optional aspects of the invention, such a blank may incorporate one or more of the following features, considered in any technically allowable combination:

The fastening means comprise at least one male part arranged at a first end of the blank and at least one female part arranged at a second end of the blank, opposite the first end of the blank, that female part being able to receive the first end and jam it in place.

Two housings for the blank that are juxtaposed in the longitudinal direction are separated by a bar for positioning an elastic retaining member for retaining a rolling body in an adjacent housing.

The blank is made by molding a synthetic material.

The invention also relates to a cage for a free wheel with rolling bodies that is formed from a blank as described above, bent on itself perpendicular to its longitudinal direction and whereof the fastening means are engaged.

The invention further relates to a free wheel with rolling bodies that comprises an inner ring, an outer ring, several rolling bodies each positioned in an annular space arranged radially between the inner and outer rings, as well as a cage as mentioned above that keeps the rolling bodies in position in the annular space.

Advantageously, the cage is made from a blank whereof two juxtaposed housings are separated by a bar as mentioned above, while an elastic retaining member for keeping the rolling bodies in place is mounted on each bar, the elastic member being optimally, but not necessarily, configured and arranged to interact with rolling bodies positioned in two housings situated on either side of the bar on which it is mounted.

Lastly, the invention relates to a method for assembling a free wheel as mentioned above, the method comprising at least the following steps:

a) positioning the blank flat, with its longitudinal direction rectilinear and horizontal;

b) installing a rolling body in each housing of the blank;

c) closing the blank on itself by bending it in a direction perpendicular to its longitudinal direction and causing its fastening means to engage.

Advantageously, the method comprises an additional step d) before step b) and consisting of placing retaining members for retaining the rolling bodies in the housings. In that case, it is possible to provide that the free wheel is equipped with elastic members in place on the bars, as considered above, while during step d), an elastic retaining member is mounted on each bar and the method comprises an additional step e), after step c), and consisting of mounting the cage equipped with the rolling bodies and retaining members between an inner ring and an outer ring of the free wheel, jamming a portion of each elastic member against a surface of one of the inner and outer rings.

### BRIEF DESCRIPTION OF THE DRAWINGS

The invention will be better understood and other advantages thereof will appear more clearly in light of the following description of one embodiment of a blank, a cage and a free wheel according to its principle, as well as a method for assembling such a free wheel also according to its principle, provided solely as an example and done in reference to the appended drawings, in which:

FIG. 1 is an exploded perspective view of a free wheel cage during assembly, using a blank according to the invention,

FIG. 2 is an enlarged view of detail II in FIG. 1,

FIG. 3 is a perspective view of the blank shown in FIGS. 1 and 2, equipped with rolling bodies and retaining members.

FIG. 4 is a top view of the blank shown in FIG. 3,

FIG. 5 is a cross-section along line V-V in FIG. 4,

FIG. 6 is an enlarged view of detail VI in FIG. 5,

FIG. 7 is an enlarged perspective view of an elastic retaining member used with the blank shown in FIGS. 1 to 6,

FIG. 8 is a perspective view of a free wheel cage formed from the blank shown in FIGS. 1 to 6,

FIG. 9 is a view in the direction of arrow IX of the cage of FIG. 8,

FIG. 10 is a side view, with the same orientation as FIG. 8, of a free wheel according to the invention incorporating the cage of FIGS. 8 and 9,

FIG. 11 is a cross-section along line XI-XI in FIG. 10,

FIG. 12 is a cross-section along line XII-XII in FIG. 11, and

FIG. 13 is an enlarged view of detail XIII in FIG. 12.

### DETAILED DESCRIPTION OF THE INVENTION

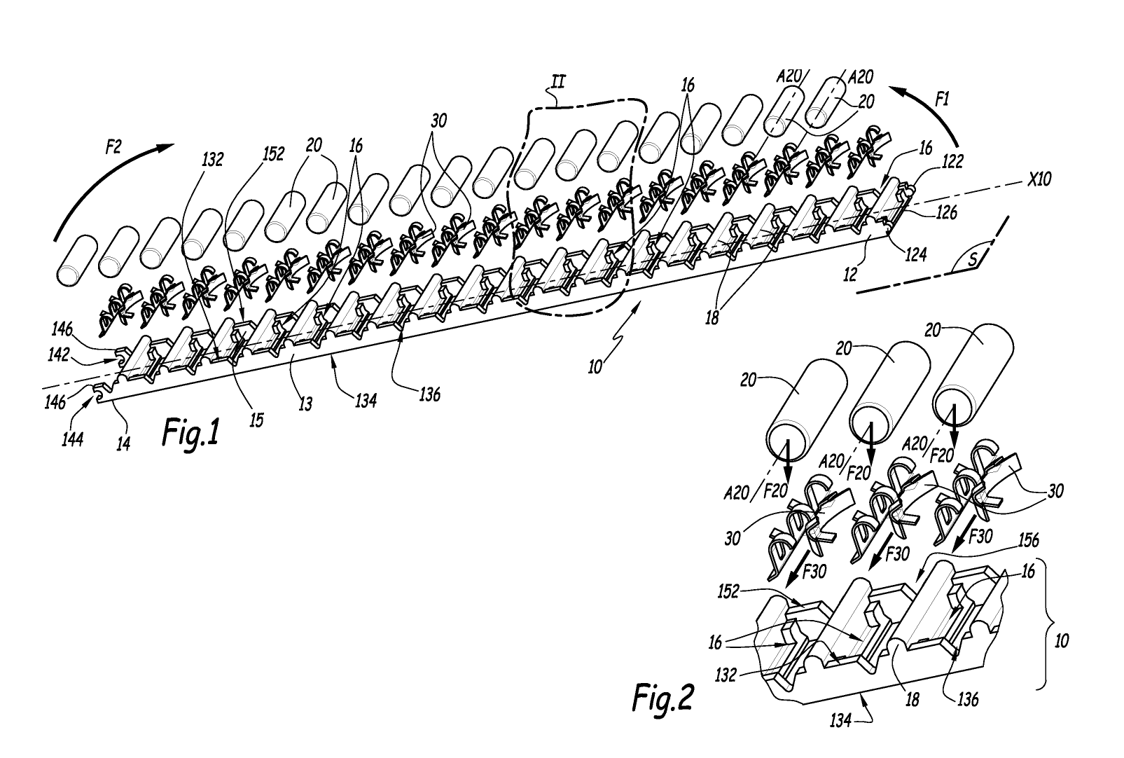

FIG. 1 shows a cage blank 10 for a free wheel. This blank is obtained by molding a plastic material, such as PA 6.6, PA 4.6 or PEEK, which may or may not be filled with glass fibers. This blank assumes the form of an elongated strip that extends in a longitudinal direction defined by an axis X10, which is horizontal and rectilinear when the blank is placed flat on a planar and horizontal surface S.

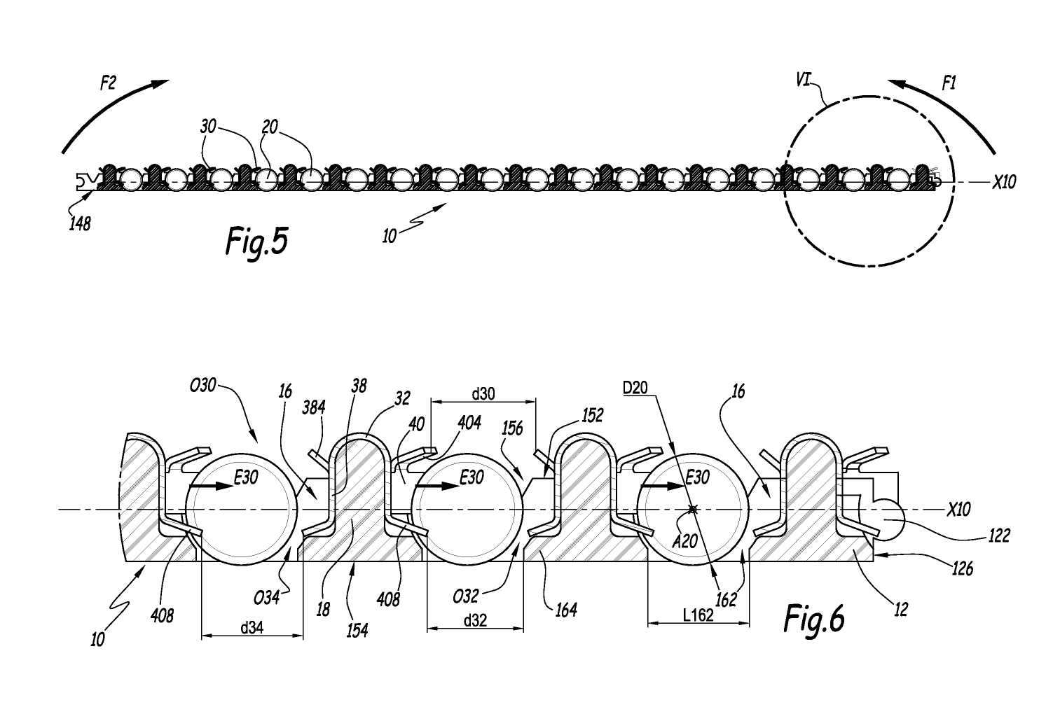

The blank 10 extends along the axis X10 between a first end 12 and a second end 14 opposite the first end 12. The end 12 is provided with two posts 122 and 124 that extend, along the axis X10, beyond a terminal and transverse edge 126 of the end 12. The end 14 defines two notches 142 and 144 for receiving and jamming the posts 122 and 124 in the closed configuration of the blank 10, that configuration being explained below. Each of the notches 142 and 144 is arranged on a tab 146 that protrudes beyond a transverse and terminal edge 148 of the end 14, that edge not being visible in FIG. 1 in light of the perspective angle, but identified in FIG. 5.

Along the axis X10, the blank 10 defines eighteen housings 16 each designed to receive a roller 20, the central axis of which is denoted A20. The nineteenth housing 16 is defined in part at the end 12, and for the additional part at the end 14. Thus, a cage formed from the blank 10 can receive nineteen rollers 20 each with its axis A20 perpendicular to the axis X10.

Two adjacent housings 16 are separated by a bar 18 that extends continuously over the entire width of the strip 10, between two side walls 13 and 15 of the blank positioned on either side of the axis X10 and parallel thereto. References 132 and 134 respectively denote the upper and lower edges of the wall 13 in the configuration of FIG. 1, the wall 13 resting on the surface S by its lower edge 134. Likewise, references 152 and 154 denote the upper and lower edges of the wall 15. The edges 134 and 154 are continuous over the length of the blank 10. The edges 132 and 152 are provided with notches 136 and 156 distributed over the length of the blank 10. More specifically, a notch 136 and a notch 156 are provided in each edge 132 and 152 at each housing 16, i.e., between each pair of two bars 18. These notches 136 and 156 give the blank 10 a flexibility in a folding direction perpendicular to the axis X10 and the axes A20 in the configurations of FIGS. 1 to 6, in the direction of arrows F1 and F2 in FIGS. 1 and 5, i.e., in a direction bringing the ends 12 and 14 closer to each other by bending the blank 10 on itself to bring the posts 122 and 124 into the notches 142 and 144 and to elastically jam them therein, by shape matching.

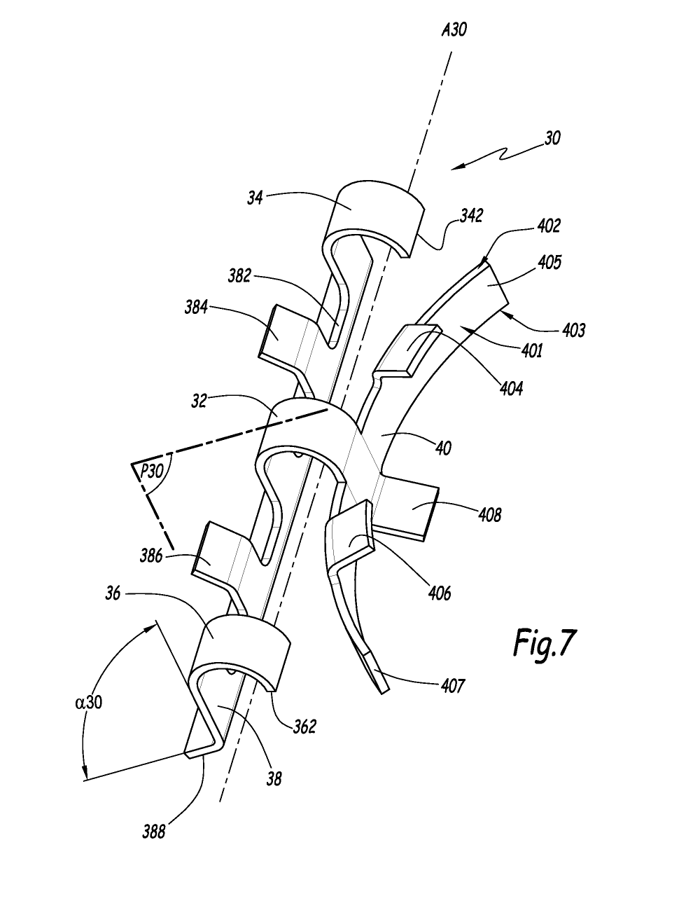

An elastic member 30 is mounted on each bar 18, said elastic member being made by folding and cutting a metal plate, preferably made from spring steel. As more particularly shown by FIG. 7, an elastic member 30 comprises three staples 32, 34 and 36 that extend from a strip 38. These staples overlap a bar 18 in the configuration with the member 30 assembled on such a bar. The staples 34 and 36 each have a free end 342, 362. Reference A30 denotes a longitudinal axis of the member 30, that axis being defined as comprising the respective curves centers of the staples 32, 34 and 36. The strip 38 is parallel to the axis A30. Opposite the strip 38, the staple 32 extends over a strip 40 that is bent, in a direction perpendicular to the axis A30, with its curve center situated opposite the axis A30 relative to the strip 40. In other words, the strip 40 is bent with its concave side opposite the strip 38. Reference P30 denotes a median transverse plane of the member 30, that plane being perpendicular to the axis A30 and passing through the middle of the staple 32. On either side of the plane P30, the strip 40 is provided with two tongues 404 and 406 that extend from the upper edge 402 of that strip closest to the staple 32, while being inclined toward the curve center of the strip 40, i.e., the side of its inner surface 401. Reference 403 denotes the lower edge of the strip 42, situated opposite the staple 32 relative to the strip. The strip 40 is equipped with a third tongue 408 that extends from the edge 403 and is situated in the extension of the staple 32 in a direction parallel to the plane P30. The tongue 408 is also inclined toward the inner surface 401 of the strip 40.

In order to improve their positioning on the bars 18 of the blank 10, the elastic members 30 may initially be configured such that the minimum distance between the strips 38 and 40, measured parallel to the plane P30, is smaller than the width of a bar X18 measured parallel to the axis X10, such that the elastic members 30 are mounted on the bars 18 using elastic deformation.

As more particularly emerges from FIGS. 6 and 7, the tongues 404 and 406 on the one hand, and the tongue 408 on the other hand, extend in diverging directions relative to the strip 40, from the edges 402 and 403, respectively.

Furthermore, reference 382 denotes an upper edge of the strip 38 from which the staples 32, 34 and 36 extend. From the edge 382, two tongues 384 and 386 also extend that are inclined opposite the axis A30, i.e., moving away from the strip 40. The strip 38 is also equipped with a border 388 that extends over the entire length of the strip 38 and forms a dihedron therewith whereof the apical angle α30 is smaller than 180°, and in practice comprised between 100° and 165°. In other words, the border 38 can be folded down opposite the axis A30 of the strip 40 relative to the strip 38.

Alternatively, a single tongue is provided on the edge 382, as is a single tongue on the edge 402. However, this alternative does not perform as well in terms of stability of the rollers 20 along their axes A20.

When a free wheel needs to be manufactured, one starts from the blank 10 positioned flat on a surface S, as shown in FIGS. 1 and 2. Each bar 18 is capped with an elastic member 30, bringing the staples of that member 30 into contact with a rounded upper zone of the corresponding bar. Thus, each elastic member 30 extends both in two housings 16 situated on either side of the bar 18 on which it is mounted, with its strip 38, its tongues 384, 386 and its border 388 positioned in a first housing 16, situated on the left of the bar 18 that it caps in FIG. 1, and its strip 40 and its tongues 404, 406 and 408 positioned in another housing 16 situated on the right of that bar in FIG. 1. Since the blank is positioned flat on the surface S, the different members 30 can be easily installed on the different bars 18, since the access to the blank 10 from above is free. It is in particular possible to provide that the different elastic members 30 are placed simultaneously on the different bars 18 or in a completely automated manner, for example using a robot. The placement of the various elastic members 30 on the different bars 18 is shown by arrows F30 in FIG. 2.

It is then possible to place the various rollers 20 in the different housings 16, by moving them in the direction of arrows F20 in FIG. 2. As with respect to the elastic members 30, the placement of the different rollers 20 is easy and can be done simultaneously or in a completely automated manner, in particular using a robot.

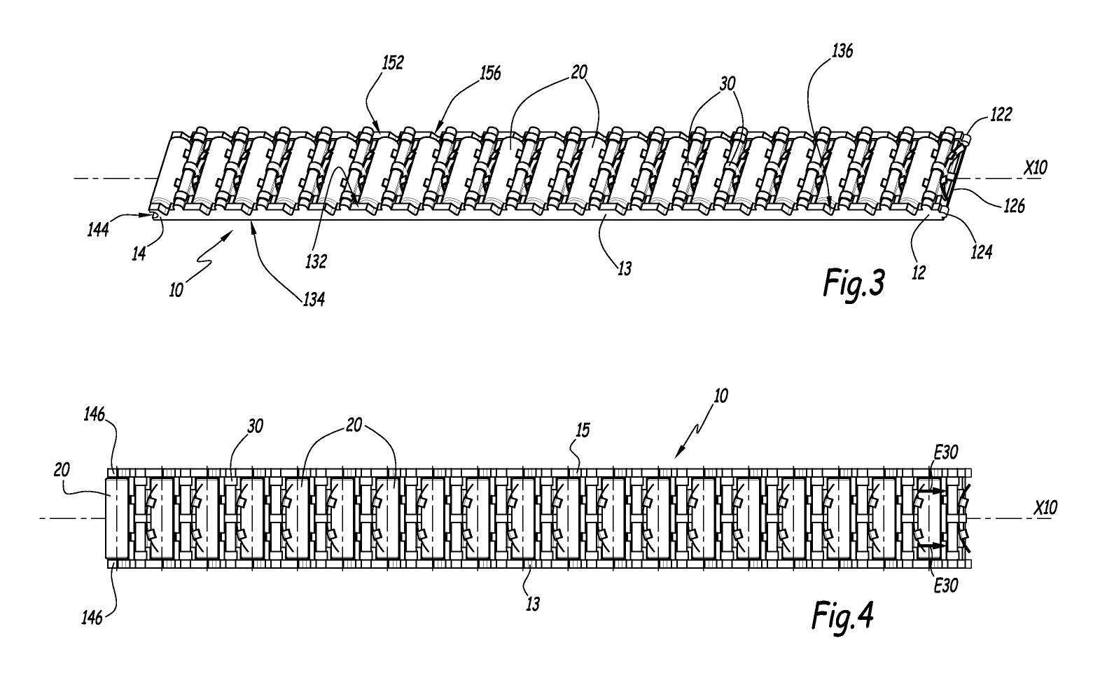

The placement of the rollers 20 takes place subject to an elastic deformation of the members 30. At the end of placement of the elements 20 and 30 on the blank 10, the configuration of FIGS. 3 to 6 is reached.

In this configuration, each roller 20 is in place in a housing 16 and may protrude below the edges 134 and 154 of the walls 13 and 15 through an opening 162 formed in the bottom of each housing 16. Reference L162 denotes the length of an opening 162 measured parallel to the axis X10. Reference D20 denotes the outer diameter of a roller 20. The length L162 is smaller than the diameter D20, such that the rollers 20 do not risk passing through the openings 162.

Reference d30 denotes a distance measured parallel to the axis X10, between the end of a tongue 404 of an elastic member 30 situated on a bar 18 and the end of a tongue 384 of a member 30 situated on an adjacent bar 18, on the right of the bar 18 equipped with the first elastic member 30. That distance d30 may also be measured between the tongues 406 and 386 of the same elastic members 30. That distance d30 corresponds to the width of an opening O30 providing access to a roller 20 from above the blank 10 equipped with the elements 20 and 30. The value of the distance d30 in the configuration of FIGS. 3 to 6 is smaller than that of the diameter D20.

A distance d32 is also considered that is measured parallel to the axis X10 between the end of a tongue 408 of an elastic member 30 and the opposite edge 164 of the adjacent opening 162. That distance corresponds to the width of an opening O32 providing access to a roller 20 from below the blank 10 equipped with the elements 20 and 30. The distance d32 is measured between an edge 164 of an opening 162 near the border 388 of a first elastic member 30 mounted on a first bar 18 and the end of the tongue 408 of a second elastic member 30 mounted on a second bar 18 situated on the left of the first bar 18, in the illustration of FIG. 6. The value of the distance d32 in the configuration of FIGS. 3 to 6 is smaller than that of the diameter D20. Thus, the tongue 408 of each elastic member 30 opposes any sliding of a roller 20 with which it interacts through the adjacent opening 162.

A distance d34 is also considered that is measured parallel to the axis X10 between the end of a tongue 408 of an elastic member 30 and the end of the border 388 opposite the strip 38. That distance d34 corresponds to the width of an opening O34 providing access to a roller 20 from above the blank 10 equipped with the elements 20 and 30, between the elastic members 30 positioned on either side of that roller. The value of the distance d34 in the configuration of FIGS. 3 to 6 is smaller than that of the diameter D20. The distance d32 is defined so as to be at most 0.050 mm smaller than the diameter D20 of the rollers 20 and at least large enough for the rollers 20 to be able to protrude from the cage 13 by 0.020 mm relative to the surface 134.

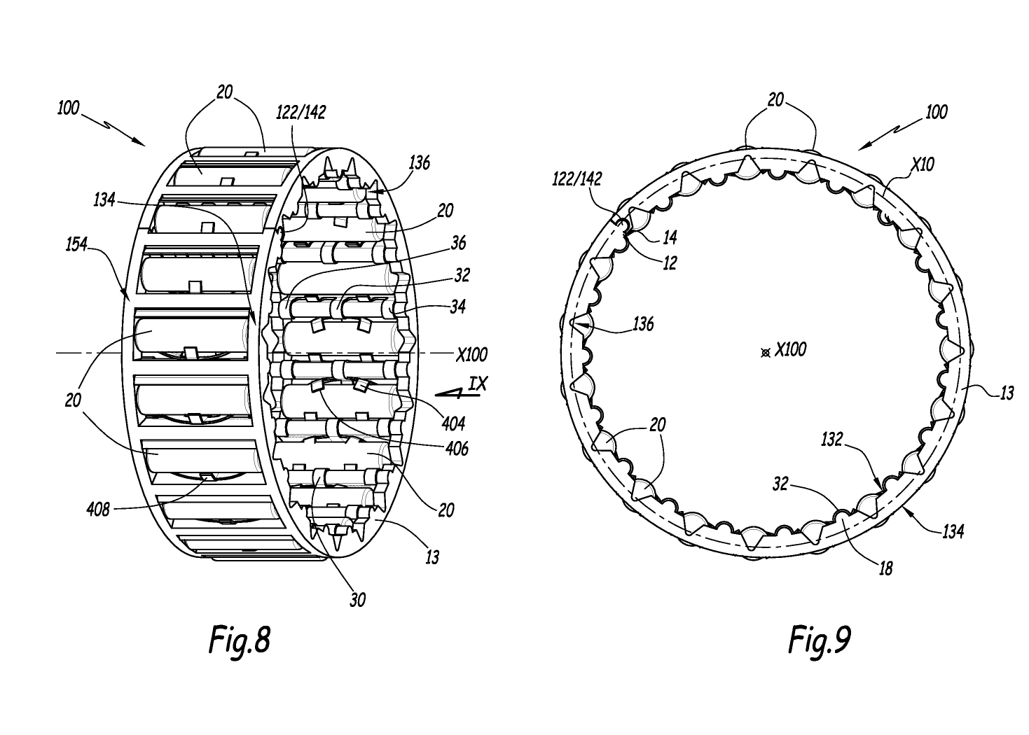

FIG. 6 shows that the tongues 408 are depicted as penetrating the rollers 20. This is a convention of the drawing that accounts for the fact that, in reality, the tongues 408 are elastically deformed by their interaction with the rollers 20. The same is true for FIGS. 4 and 8, where the elastic deformation of the strips 40 is not shown.

Furthermore, as shown more particularly by FIG. 4, the concave nature of the strip 40 causes its ends 405 and 407 to exert, on an adjacent roller 20, an elastic force E30 oriented toward the elastic member 30 situated on the other side of the housing 16.

When all of the rollers 20 and all of the elastic members 30 are in place on the blank, it is possible to bend that blank in the direction of arrows F1 and F2 in FIG. 1 to cause an engagement between the complementary raised portions provided at its ends 12 and 14, i.e., the posts 122 and 124, on the one hand, and the notches 142 and 144, on the other hand. This results in closing the notches 136 and 156 on themselves and bringing the tongues 404 and 406 of each elastic member 30 closer to the tongues 384 and 386 of the elastic member 36 situated on the other side of a housing 16. This then results in the configuration of FIGS. 8 and following, where a cage 100 is made up of the blank 10 folded on itself to form a closed loop. Reference X100 denotes the central axis of that cage 100, which is parallel to the respective central axes A20 of the rollers 20 and around which the axis X10 forms a closed circle.

In this configuration, the rollers 20 protrude radially inward, through the openings 030 and toward the axis X100, from the edges 132 and 152, whereas they also protrude, radially outward, through the openings 162, O32 and O34 and opposite the axis X100, from the edges 134 and 154. Since each roller 20 is kept in place in its housing 16 due to their geometry on the one hand and under the action of the elastic members 30 positioned on either side in a direction orthoradial to the axis X100 on the other hand, the cage equipped with the members 20 and 30 can be manipulated without any special precautions, such as a mechanical sub-assembly able to incorporate a free wheel.

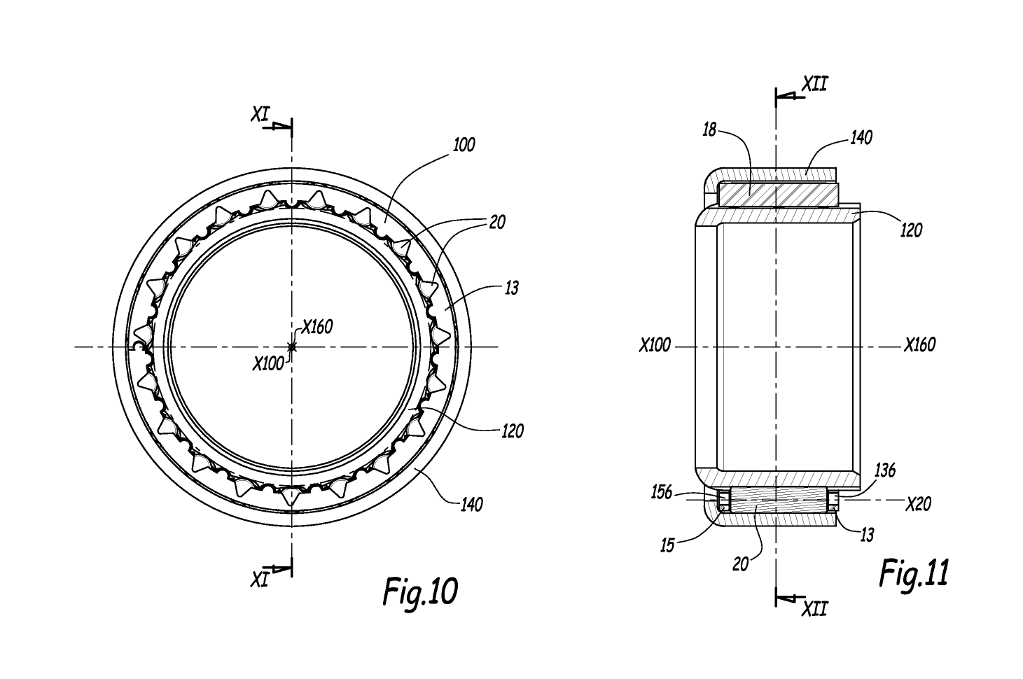

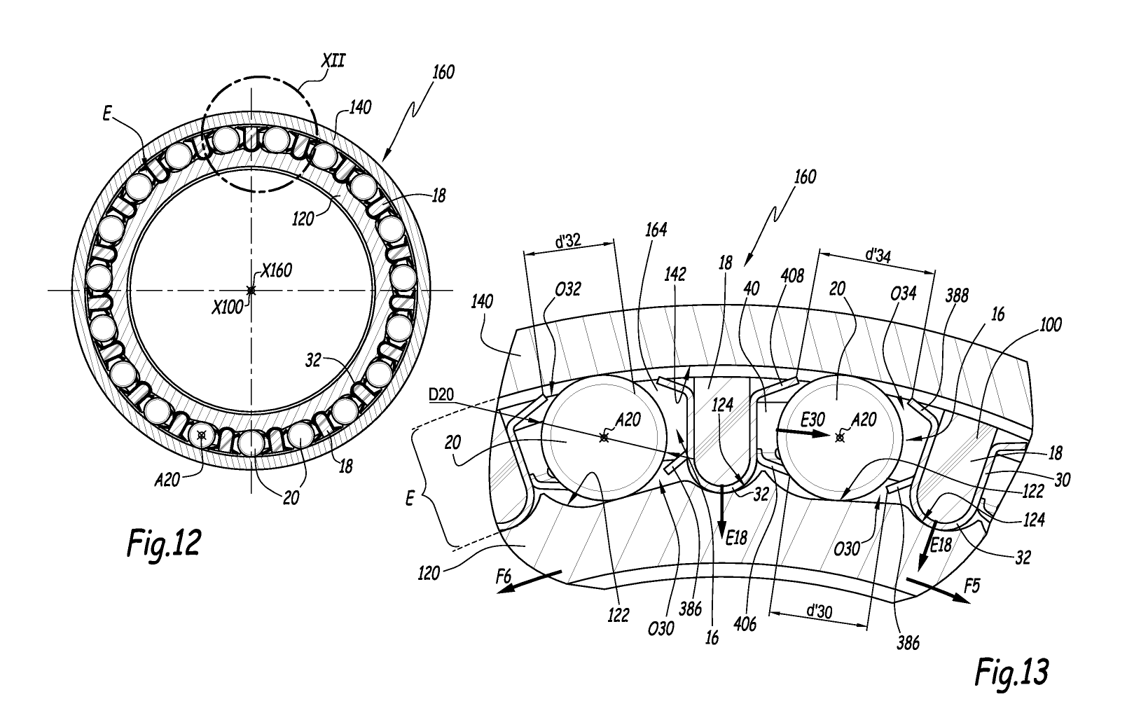

More specifically, when there is cause to manufacture a free wheel like that shown in FIGS. 10 to 13, with reference 160, the sub-assembly formed by the cage 100 equipped with the elements 20 and 30 is inserted into a radial annular space E defined between an inner ring 120 and an outer ring 140 of the free wheel.

References 122 and 142 respectively denote the rolling tracks of the rollers 20 on the rings 120 and 140. As more particularly shown in FIG. 13, the track 142 is cylindrical and has a circular section, while the track 122 forms a cam surface. When the ring 120 tends to rotate relative to the ring 140 in the direction of arrow F5 in FIG. 13, the rollers 20 roll on the tracks 122 and 142 and a relative rotational movement is possible. When the inner ring 120 tends to rotate relative to the ring 140 in the direction of arrow F6 in FIG. 13, the rollers 20 are jammed between the tracks 122 and 142, such that the ring 120 drives the ring 140 in the direction of arrow F6, through the free wheel mechanism, which comprises the rollers 20.

As shown in FIG. 13, the elastic force E30 exerted by the strip 40 of an elastic retaining member 30 on the adjacent roller tends by default to return that roller toward the opposite bar 18, in a configuration where the roller is jammed between the surfaces 122 and 142. Thus, by default, the free wheel 160 is in a configuration securing the rings 120 and 140 in rotation, in the direction of arrow F6.

FIG. 13 shows that the staple 32 of each elastic member 30 is pressed by a force E18, exerted by the bar 18 on which it is mounted, inside a notch 124 arranged to that end on the track 122. The same is true of the staples 34 and 36. Thus, the cage is immobilized in rotation relative to the inner ring 120 and the various elastic members 30 are kept firmly in place on the bars 18.

In the assembled configuration of the free wheel 160, the axes A30, A20 and X100 are parallel, the axis X100 in practice being combined with the central axis X160 of the free wheel that is the axis of rotation of the rings 120 and 140 relative to one another. In particular, the tongues 404 and 408 on the one hand, and 384 and 386 on the other hand, are offset along the axis X160.

As shown by FIG. 13, due to the bending of the blank 10, the width of the opening O30 in the assembled configuration of the free wheel 160, which is measured in a direction orthoradial to the axes X100 and X160, assumes a value of d30 lower than the value d30,therefore lower than the value of the diameter D20. This guarantees that the rollers will be kept in the cage 100, in particular in the configuration of FIGS. 8 and 9.

In this assembled configuration of the free wheel 160, the widths of the openings O32 and O34, which are also measured in directions orthoradial to the axes X100 and X160, assume values of d32 and d34 slightly higher than the values d32 and d34, but lower than the value of the diameter D20. In FIG. 13, the geometry of the cage 10 is not very different from that shown in FIG. 6, which makes it possible to see an alternative embodiment of the cage 100 and, consequently, of the blank 10. In that context, the opening O32 is shown on the left in this figure from the axis line outline of an edge 164 comparable to that shown in FIG. 6 with the same reference.

According to another alternative, rolling bodies other than rollers can be used with the blank 10, the cage 100 and the free wheel 160 of the invention, for example free wheel-type profiled cams.

According to still another alternative, the notches 136 and 156 may be provided on the edges 134 and 154 of the walls 13 and 15.

The embodiments and alternatives considered above may be combined to generate new embodiments.

1. A cage blank for a free wheel with rolling bodies comprising:
an elongated strip defining housings for receiving the rolling bodies juxtaposed in a longitudinal rectilinear direction (X10) of the blank and
fastening means disposed at both ends of the blank for fastening the two ends together, in a configuration where the cage forms a closed loop.

2. The cage blank according to claim 1, wherein the fastening means includes at least one male part arranged at a first end of the blank and at least one female part arranged at a second end of the blank, opposite the first end of the blank, the female part being able to receive the first end and jam it in place.

3. The cage blank according to claim 1, further comprising two housings for the blank that are juxtaposed in the longitudinal direction are separated by a bar for positioning an elastic retaining member for retaining a rolling body in an adjacent housing.

4. The cage blank according to claim 1, further comprising being made by molding a synthetic material.

5. A cage for a free wheel with rolling bodies comprising:
a formed blank having an elongated strip defining housings for receiving the rolling bodies juxtaposed in a longitudinal rectilinear direction (X10) of the blank and fastening means disposed at both ends of the blank for fastening the two ends together in a configuration where the cage forms a closed loop, wherein
the blank is formed on itself perpendicular to its longitudinal direction (X10) and where the fastening means are engaged.

6. A free wheel with rolling bodies, comprising:
an inner ring,
an outer ring,
a plurality of rolling bodies each positioned in an annular space (E) arranged radially between the inner and outer rings,
a cage that keeps the rolling bodies in position in the annular space, and
a formed blank having an elongated strip defining housings for receiving the rolling bodies juxtaposed in a longitudinal rectilinear direction (X10) of the blank and fastening means disposed at both ends of the blank for fastening the two ends together in a configuration where the cage forms a closed loop, and wherein
the blank is formed on itself perpendicular to its longitudinal direction (X10) and where the fastening means are engaged.

7. The free wheel according to claim 6, wherein the cage (100) is made from a blank having two housings for the blank that are juxtaposed in the longitudinal direction are separated by a bar for positioning an elastic retaining member for retaining a rolling body in an adjacent housing, and
an elastic retaining member for keeping the rolling bodies in place is mounted on each bar, the elastic member preferably being configured and arranged to interact (E30) with rolling bodies positioned in two housings situated on either side of the bar on which it is mounted.

8. A method for assembling a free wheel having an inner ring, an outer ring, a plurality of rolling bodies each positioned in an annular space (E) arranged radially between the inner and outer rings, a cage that keeps the rolling bodies in position in the annular space, and a formed blank having an elongated strip defining housings for receiving the rolling bodies juxtaposed in a longitudinal rectilinear direction (X10) of the blank and fastening means disposed at both ends of the blank for fastening the two ends together in a configuration where the cage forms a closed loop, and wherein the blank is formed on itself perpendicular to its longitudinal direction (X10) and where the fastening means are engaged; comprising the steps of:
a) positioning the blank flat, with its longitudinal direction (X10) rectilinear and horizontal;
b) installing a rolling body in each housing of the blank;
c) closing the blank on itself by bending it (F1, F2) in a direction perpendicular to its longitudinal direction and causing its fastening means to engage.

9. The method according to claim 8, further comprising a step before step c) and consisting of:
d) placing retaining members for retaining the rolling bodies in the housings.

10. The method according to claim 9, wherein the free wheel includes an inner ring, an outer ring, a plurality of rolling bodies each positioned in an annular space (E) arranged radially between the inner and outer rings, a cage that keeps the rolling bodies in position in the annular space, and a formed blank having an elongated strip defining housings for receiving the rolling bodies juxtaposed in a longitudinal rectilinear direction (X10) of the blank and fastening means disposed at both ends of the blank for fastening the two ends together in a configuration where the cage forms a closed loop,
wherein the blank is formed on itself perpendicular to its longitudinal direction (X10) and where the fastening means are engaged, and
wherein the cage is made from a blank having two housings for the blank that are juxtaposed in the longitudinal direction are separated by a bar for positioning an elastic retaining member for retaining a rolling body in an adjacent housing, and
an elastic retaining member for keeping the rolling bodies in place is mounted on each bar, the elastic member preferably being configured and arranged to interact (E30) with rolling bodies positioned in two housings situated on either side of the bar on which it is mounted, and wherein
during step d), an elastic retaining member is mounted on each bar, and the method provides an additional step, after step c), and consisting of:
e) mounting the cage equipped with the rolling bodies and retaining members between an inner ring and an outer ring, jamming (E18) a portion of each elastic member against a surface of one of the inner and outer rings.
